(19) United States
(12) Patent Application Publication
(10) Pub. No.: US 2025/0004442 A1
(43) Pub. Date: Jan. 2, 2025

(54) METHOD FOR OPERATING A MACHINE TOOL

(71) Applicant: P&L GmbH & Co. KG, Soltau (DE)

(72) Inventor: Jürgen RÖDERS, Soltau (DE)

(21) Appl. No.: 18/705,854

(22) PCT Filed: Nov. 2, 2022
(86) PCT No.: PCT/EP2022/080522

§ 371 Date: Apr. 29, 2024

(30) Foreign Application Priority Data
Nov. 11, 2021 (DE) 10 2021 129 378.2

(51) Int. Cl. G05B 19/4069; G05B 19/416

(52) U.S. Cl. CPC G05B 19/4069; G05B 19/416; G05B 2219/36252; G05B 2219/37602

(57) ABSTRACT

The invention relates to a method for operating a machine tool which is configured for machining a workpiece blank using a tool, said method comprising the steps of: determining geometry data of the workpiece blank, determining geometry data of a tool used for machining the workpiece blank, dividing a tool path for machining the workpiece blank into a plurality of route increments, simulating a removal of material on the workpiece blank by means of the tool per route increment, and calculating engagement ratios between the workpiece blank and tool per route increment for determining engagement parameters, wherein an advancement and/or a rotational speed of the tool (2) are adjusted depending on the calculated engagement parameters.

### CROSS-REFERENCE TO RELATED APPLICATIONS

This application is a national phase filing under 35 U.S.C. § 371 of International Application No. PCT/EP2022/080522, filed on Nov. 2, 2022, which claims priority to German Patent Application No. DE102021129378A, filed on Nov. 11, 2021, the entire content of each application is incorporated by reference herein.

### FIELD OF THE DISCLOSURE

The invention relates to a method for operating a machine tool, in particular for milling or grinding, and to a machine tool which is configured to carry out the method.

### BACKGROUND OF THE DISCLOSURE

Machine tools and methods for operating machine tools are known in various embodiments from the prior art. NC (Numerical Control) and CNC (Computerised Numerical Control) machine tools are known, which process commands in succession based on a control program, in order to carry out different machining operations on a workpiece. Machining operations of this kind have proven themselves in practice, but cases of use exist in which highly precise machining or a very good surface quality is necessary. In addition, in the case of unfavorable programming of the control program overloading of the tool or the mandrel of the machine sometimes occurs.

The object of the present invention is therefore that of providing a method for operating a machine tool, and of providing a machine tool, which, with a simple design and simple workability enables a significant improvement in precision of machining of a workpiece and/or a surface quality, and avoids overloading of the mandrel or tool.

### SUMMARY OF THE DISCLOSURE

The present disclosure provides, in one aspect, a method for operating a machine tool configured for machining a workpiece blank using a tool, the method comprising the steps of determining geometry data of the workpiece blank, determining geometry data of a tool used for machining the workpiece blank, diving a tool path for machining thee workpiece blank into a plurality of route increments, simulating a material removal on the workpiece blank by means of the tool per the route increment, calculating engagement ratios between the workpiece blank and tool per the route increment for determining an engagement parameter, wherein an advancement and/or a rotational speed of the tool relative to the workpiece blank is adjusted depending on the calculated engagement parameter.

The method according to the present disclosure provides, in another aspect, that highly precise machining of a workpiece blank using a tool, and/or better surfaces, are possible, and overloading of the mandrel and/or tool is avoided. In this case, a particularly significant advantage results when a workpiece has to be produced multiple times in succession. In this case, the method according to the invention takes into account geometry data of the workpiece blank and geometry data of tools used for the machining. In this case, the method according to the invention comprises a step of determining the geometry data of the workpiece blank, and a step of determining geometry data of a tool used for machining the workpiece blank. The geometry data of the workpiece blank are preferably provided by detection, by means of measuring technology, of the dimensions of the workpiece blank prior to machining. Alternatively, the geometry data of the workpiece blank can also be taken from a CAD system and/or a memory of a controller of the machine tool. In this case, the detection of the dimensions of the workpiece blank by means of measuring technology offers the most precise machining option. Furthermore, geometry data of the tool used for machining are preferably also taken from a memory. Alternatively, a detection of geometry data of the tool that is used takes place by means of measuring technology.

The method according to the present disclosure provides, in another aspect, a step of dividing a tool path for machining the workpiece blank into a plurality of route increments. In this case, a size of the respective route increments can be selected freely. A route increment may be selected to be so short that, at a given path speed (a given advancement) of a path, on which the tool and workpiece blank move relative to one another, and a given rotational speed of the tool, it corresponds only to the route that the tool travels during one or just a few, at most five, rotations relative to the workpiece for material removal.

The present disclosure provides, in another aspect, that a material removal on the workpiece blank by means of the tool is simulated, per route increment. Subsequently, based on the simulation engagement ratios between the workpiece blank and tool are calculated per route increment, and a relative movement between the tool and workpiece blank, in particular an advancement and/or a rotational speed of the tool, relative to the workpiece blank, is adjusted depending on the calculated engagement parameters.

The present disclosure provides, in another aspect, a method that makes it possible to significantly improve the precision of the machining of a workpiece blank and/or the surface quality, and for overloading of components of the machine tool to be avoided, such that production of a workpiece that corresponds exactly to the predetermined dimensions and requirements is possible.

The present disclosure provides, in another aspect, that the method may be carried out directly in a controller of the machine tool.

The present disclosure provides, in another aspect, that a length of a route increment corresponds to the route that the tool travels, in the case of a predetermined path speed and a predetermined rotational speed, during 1 to 5 rotations of the tool. The selection of these relatively small route increments makes it possible, in particular taking into account the previously calculated engagement ratios between the workpiece blank and tool, to very successfully simulate the removal of material by the tool.

The present disclosure provides, in another aspect, that the engagement ratios are determined based on a material volume which is removed from the workpiece blank by the tool during a relative movement between the tool and workpiece blank along a route increment.

The present disclosure provides, in another aspect, that the engagement ratios are ascertained based on an immersion depth of the tool into the workpiece blank. The immersion depth corresponds to a difference between a lowest contact point and a highest contact point of the tool in the material of the workpiece blank in the direction of the axis of rotation of the tool.

The present disclosure provides, in another aspect, that the engagement ratios are determined based on a wrapping. The wrapping specifies the angular region over which a cutting edge of the tool is in engagement with the material of the workpiece blank during a rotation of the tool. In the case of what is referred to as a full cut, in which the tool forms a groove in the workpiece blank for example, the wrapping is at most 180°.

The present disclosure provides, in another aspect, that the engagement ratios are determined based on a size of a surface which is in contact with the material of the workpiece blank. In this case, the surface is defined by a bounding volume of the tool which results due to the rotation of the tool.

The present disclosure provides, in another aspect, the engagement ratios are determined based on an angle of a path between the tool and workpiece blank, relative to the axis of rotation of the tool. If the angle is less than 90°, immersive machining of the tool in the workpiece blank takes place. In this case, the tool is immersed axially into the workpiece. If the angle is larger than 90°, then pulling processing of the workpiece blank takes place.

Thus, for each route increment, one or more engagement parameters for the engagement ratios can be calculated by a controller of the machine tool.

The present disclosure provides, in another aspect, a calculation of the engagement parameters of the engagement ratios for each individual route increment takes place temporally first, before the tool is moved along the calculated route increment, relative to the workpiece blank. Determining the engagement parameters of the engagement ratios for each individual route increment temporally slightly before, in the controller, makes it possible for the advancement and/or rotational speed to still be adjusted before the machining along the calculated route increment takes place. The controller is thus able to still change the parameters of advancement and/or rotational speed, which are essential for machining, shortly before the machining along the route increment. As a result, for example the machining precision can be increased, in that for example the advancement and/or the rotational speed is reduced along route increments having greater material removal. In particular, in the case of engagement parameters, along a route increment, which are too high, undesired vibrations can be prevented, which lead to inaccuracies or poor surfaces. Overloading of the tool can also be prevented in this way. Thus, in the case of machining of the workpiece blank, an adjustment of the machining can take place, and this can in particular be optimized.

The present disclosure provides, in another aspect, that if the volume of the material removal along one route increment is greater, an advancement and/or a rotational speed of the tool can be reduced, in order to reduce loading of the tool and mandrel of the machine tool.

The present disclosure provides, in another aspect, that if the volume of the material removal along one route increment is particularly small, the advancement and/or rotational speed of the tool can be selected to be greater, in order to reduce a machining time.

The present disclosure provides in another aspect, that one or more characteristic curves for engagement parameters are stored in a controller of the machine tool for each tool that is used for machining the workpiece blank. In this case, the characteristic curves specify how the advancement and/or rotational speed of the tool relative to the workpiece are adjusted for individual calculated engagement parameters, for example a material volume and/or an immersion depth and/or a wrapping and/or an engaged bounding volume and/or a path angle between the tool and workpiece blank. The characteristic curve determines the advancement and/or rotational speed depending on the engagement ratios which occur during the machining along a route increment and are recalculated for each route increment.

The present disclosure provides, in another aspect, a method wherein during machining, vibrations and/or machining forces calculated from motor currents of at least one electric drive, in particular at least one advancement shaft or mandrel shaft, are detected by sensors, for example on the mandrel, or also indirectly by route measurement sensors in the shafts of the machine tool. If the measured vibrations and/or calculated machining forces are low, the advancement and/or rotational speed could be increased without the machining result being impaired or the mandrel or the tool being overloaded. If, in the case of machining, the measured vibrations and/or calculated machining forces for the machining process, the mandrel or the tool are high, the advancement and/or rotational speed would have to be reduced. If a change of the advancement and/or rotational speed for the route increment in which the values for the measured vibrations and/or calculated machining forces are high or low is no longer possible in terms of time, since the machining is already taking place, the characteristic curve for the tool currently in use, for the engagement parameter(s) in question, is adjusted by the controller. If the measured vibrations and/or calculated machining forces are high, the characteristic curve for the advancement and/or rotational speed for the tool, in the range for the calculated engagement parameters, drops, in order that, in the case of a future route increment in the tool path in which the calculated engagement parameter is of the same magnitude, the controller carries out the machining in accordance with the changed characteristic curve, with reduced advancement and/or reduced rotational speed. If the measured vibrations and/or calculated machining forces are low, the characteristic curve correspondingly rises in the region for the calculated engagement parameters. Thus, a self-optimizing, self-learning system results. In order that the characteristic curves are not continuously changed during machining, in addition to the division of the measured vibrations and/or calculated machining forces into high and low, a central region, in particular a deviation of ±5%, can also be defined, which is considered suitable, for example. If the measured vibrations and/or calculated machining forces fall into this region, then no change of the characteristic curve takes place. Since, during machining, the calculated engagement parameters usually vary in a particular value range, the characteristic curve or the characteristic curves for advancement and/or rotational speed are automatically optimized for this value range. After a short machining time, only suitable value should then result for measured vibrations and/or calculated machining forces, for different calculated engagement parameters.

The present disclosure provides, in another aspect, during machining, vibrations and/or machining forces that are calculated from motor currents of the electric drive of the advancement shaft or the mandrel shaft are detected, in particular by means of sensors, and, in the case of a predetermined limit value not being met, the characteristic curve for the tool that is used rises in the region of the calculated engagement parameter for advancement and/or rotational speed, in order to, in the future, increase a machining speed at a constant machining quality, if the engagement parameter is again calculated at the same magnitude, in the case of machining along a route increment. If the detected values for vibrations and/or machining forces exceed predetermined limit values, the characteristic curve for the tool that is used drops in the region of the calculated engagement parameter for advancement and/or rotational speed, in order to, in the future, reduce a machining speed if the engagement parameter is again calculated at the same magnitude, in the case of machining along a route increment.

The present disclosure provides, in another aspect, the characteristic curves are dependent on the material properties. If one tool is used for different materials or one material having different hardnesses, a separate characteristic curve is stored, for the respective tool, for each material property, e.g. different material or different hardness. A separate characteristic curve is defined for each material property of a workpiece blank in conjunction with a tool, which characteristic curve is adjusted to calculated engagement parameters for future machining.

The present disclosure provides, in another aspect, the regions for assessing whether the measured vibrations and/or calculated machining forces are high, low or suitable are defined separately for each tool. For instance, a large tool for pre-machining can be used with significantly higher loading with respect to measured vibrations and/or calculated machining forces, compared with a delicate tool for final machining. It is therefore expedient, in addition to the characteristic curves for individual tools for setting the advancement and/or rotational speed, to also store limit values, in the controller, for distinguishing between high, suitable or low measured vibrations and/or calculated machining forces for each tool and optionally each material to be machined.

The present disclosure provides, in another aspect, the characteristic curves thus optimized during machining are stored in the controller, in order that these are available for subsequent machining of a further workpiece using the same tool.

The present disclosure provides, in another aspect, that possible wear of the tools is determined. If the measured vibrations and/or calculated machining forces are neither high nor low, and therefore suitable, during machining along a route increment, it can be assumed that the machining is already taking place with optimal values for the advancement and/or rotational speed. The characteristic curve is, as described above, no longer changed in this region for the calculated engagement parameters, and can additionally be designated as optimized in said region. If, at a later time during the machining, the calculated engagement parameter falls into a region of the characteristic curve that was designated as optimized, but the measured vibrations and/or calculated machining forces are no longer suitable, but rather deviating, e.g. high or low, it can be concluded from this that the machining as a whole is no longer progressing optimally, in particular that the tool is worn and the values for measured vibrations and/or calculated machining forces have therefore worsened.

The present disclosure provides, in another aspect, the controller can react differently to a determination of possible wear of the tool, depending on the machining task. In one embodiment, the machining of the workpiece using the tool can be interrupted, and possibly continued using a new or intact sister tool. In another embodiment, for instance in the case of only slight exceeding, e.g. ±2%, of the suitable range for measured vibrations and/or calculated machining forces the machining can be continued using a second, temporarily dropped, characteristic curve for the tool, until the difference with respect to machining using an unworn tool becomes too great, and only then is the machining interrupted.

The present disclosure provides, in another aspect, wear monitoring functions well in particular if the characteristic curves are already well optimized by prior machining operations. In this case, the wear monitoring can not only detect wear of the tool, but rather also other anomalies in the machining, e.g. if a tool has a significant imbalance and thus vibrates significantly and would lead to a poor machining result.

The present disclosure provides, in another aspect, the combination of calculating the engagement parameters and determining measured vibrations and/or calculated machining forces thus makes possible very effective monitoring of the machining process.

The present disclosure provides, in another aspect, that overloading of the tool or the mandrel, or a collision, can be prevented by a temporally preceding calculation of the engagement parameters along a tool path. If it is determined, when calculating the engagement parameters, that the tool should perform the material removal using a portion n the tool on which no cutting edges are actually located, for example on the tool shaft, this can be identified as an impending collision and the machine can be stopped by the controller, before this collision occurs. In the same way, overloading of the tool or the mandrel can be prevented if engagement parameters that are very high, and inadmissibly high for the tool or the mandrel, are determined, for example by the temporally preceding calculation of the engagement parameters. Then, too, it is still possible to stop the machine before impending overloading of the tool or mandrel, by means of the controller.

The present disclosure provides, in another aspect, that an error in the machining can also be detected, if the vibration values just measured are much lower than suitable, although the characteristic curve is already optimized in the range for the calculated engagement parameter. In this case, the tool can be interrupted for example, and thus no longer be in engagement.

The present disclosure provides, in another aspect, the characteristic curves for advancement and/or rotational speed can be dependent on one or more calculated engagement parameters. This can be different for each individual tool.

The present disclosure provides, in another aspect, a machine tool which is configured to carry out the method according to the invention. The machine tool comprises a controller and a memory, in which the method according to the present disclosure is carried out and engagement parameters of engagement ratios are calculated and characteristic curves for advancement and/or rotational speed are stored depending on the calculated engagement parameters and ranges for measured vibrations and/or calculated machining forces.

The present disclosure provides, in another aspect, a method that keeps a ratio of rotational speed to advancement constant. That is to say that the advancement and rotational speed are always changed proportionally, such that the quotient of rotational speed divided by the advancement remains constant.

### BRIEF DESCRIPTION OF THE DRAWINGS

FIG. 1 is a schematic illustration of a method according to the disclosure for operating a machine tool.

FIG. 2 is a perspective view of a machine tool for carrying out the method of FIG. 1.

FIG. 3 is a graph illustrating a characteristic curve for an engagement parameter.

FIG. 4 is a graph illustrating a characteristic curve for an engagement parameter.

FIG. 5 is a graph illustrating a characteristic curve for an engagement parameter.

### DETAILED DESCRIPTION

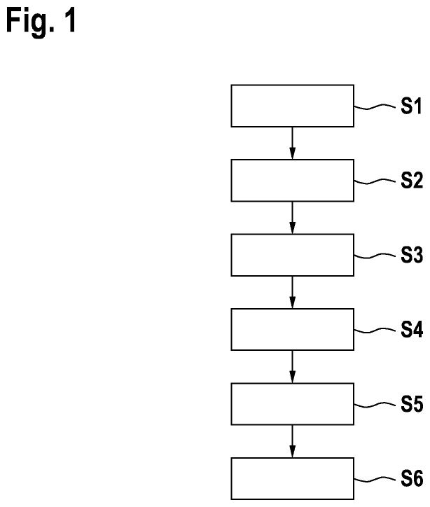

A course of the method for operating a machine tool 1 is shown below with reference to FIG. 1 to 5.

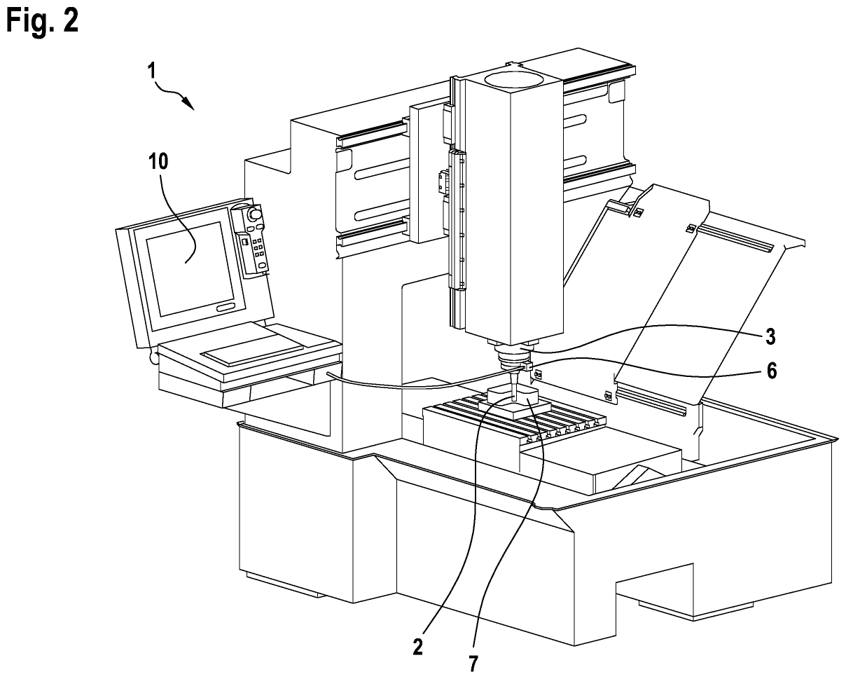

FIG. 2 is a schematic, perspective view of a machine tool 1 for carrying out the method according to the invention. The machine tool 1 comprises a mandrel 3 having a clamped tool 2 which machines a workpiece blank 7. For detecting vibrations, a sensor 6 is arranged on the mandrel 3. The machine tool 1 further comprises a controller 10 having a memory.

In a first step S1, the method (cf. FIG. 1) determines geometry data of a workpiece blank 7. These geometry data can be determined in advance by detecting the dimensions of the workpiece blank 7, or taken from a construction system (CAD system), or be previously already stored in a memory and taken from there.

In step S2 geometry data of a tool 2 used for machining the workpiece blank 7 are determined. Said geometry data can also preferably be taken from a memory or alternatively be determined by measuring the tool 2.

It is noted that steps S1 and S2 can also be carried out simultaneously, or step S2 can be carried out before step S1.

In a third step S3, the tool path for machining the workpiece blank 7 is divided into a plurality of small route increments. In this case, a route increment is preferably so short that, at a given path speed of the tool 2 relative to the workpiece blank 7, and a given rotational speed of the tool 2, it corresponds only to the route that the tool 2 travels during one or just a few rotations, at most five rotations, relative to the workpiece blank 7 for the material removal.

Step S3 can also be carried out at the same time as steps S1 and S2, or also already be specified in the controller.

In step S4 a material removal on the workpiece blank 7 by means of the tool 2, per route increment, is simulated. For each of the route increments, the length of which is specified in this way, the controller calculates, in step S5, on the basis of the simulation, engagement ratios between the tool 2 and workpiece blank 7, by which material is removed, over the length of the route increment, owing to the relative movement between the tool 2 and workpiece blank 7.

In step S6, a speed of the relative movement between the tool 2 and the workpiece blank 7, and/or a rotational speed of the tool 2, are then adjusted depending on the calculated engagement parameters for the machining of the workpiece blank 7.

Thus, according to the invention, highly precise machining can be made possible on the basis of simulation results of engagement ratios between the workpiece blank 7 and tool 2. In this case, the engagement ratios can be determined based on different parameters, for example a material volume which is removed by the tool 2 and/or an immersion depth of the tool 2 into the workpiece blank 7 and/or a wrapping, by means of which a cutting edge of the tool 2 is in engagement with the workpiece blank 7 during a rotation, and/or a size of a surface of a bounding volume of the tool 2, which results due to a tool rotation, and/or an angle of a path between the tool 2 and workpiece blank 7 relative to an axis of rotation of the tool 2 and/or a material of the workpiece.

The more parameters of engagement ratios are calculated in this case, the more precisely machining of the workpiece blank 7 can take place.

Particularly preferably, the calculation of the engagement parameters of the engagement ratios for each individual route increment takes place temporally first, before the controller moves the shafts of the machine tool 1 along the route increment, in order to perform the actual machining. The results of the calculation of the engagement parameters can then be used to adjust, and thus optimize, the machining in said route increment.

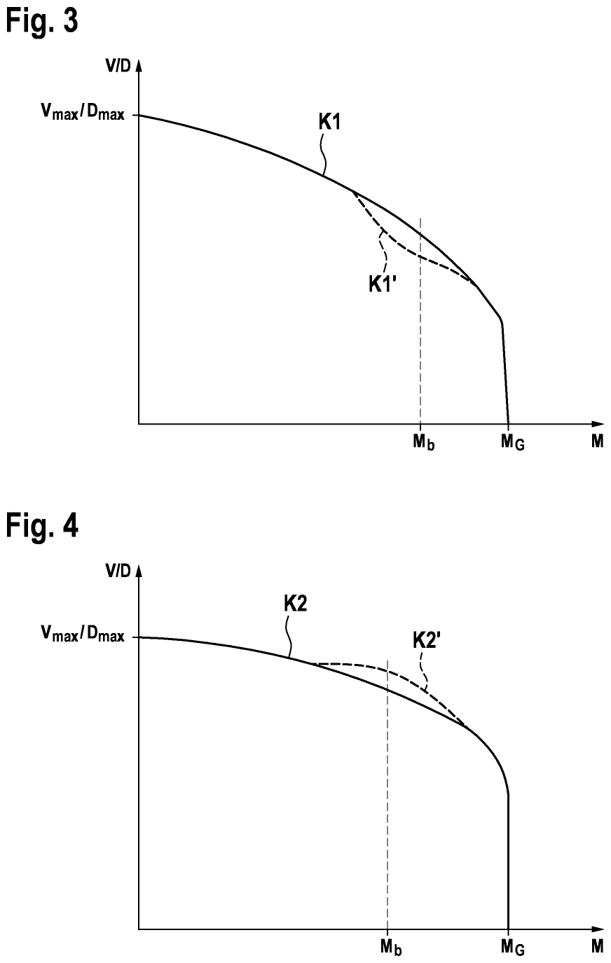

FIG. 3 to 5 show characteristic curves for a rotational speed and/or an advancement (path speed), depending on a calculated engagement parameter. In this embodiment, the calculated material volume, which is removed during a route increment, is shown as the calculated engagement parameter. For reasons of simplification, the embodiment uses, as the single calculated engagement parameter, only the calculated material volume, for evaluating the characteristic curve. In practice, a characteristic curve is preferably determined from a plurality of calculated engagement parameters. In this case, it is also possible for weighting of the calculated engagement parameters to be performed. FIG. 3 shows the advancement V or the rotational speed D over the material volume M, which is recorded per route increment. It is clear from the characteristic line K1 of the engagement parameter that is shown, that the advancement V and/or rotational speed D are reduced as the material volume M increases. In this case, a ratio of advancement V to rotational speed D preferably remains constant. A maximum advancement Vₘₐₓ and/or a maximum rotational speed Dₘₐₓ is present when the material volume M is close to zero. As is furthermore visible from FIG. 3, the advancement V and/or rotational speed D drop with increasing material volume M per route increment, in accordance with the characteristic curve K1. M_{G} denotes a material limit volume at which the maximally admissible loading of the tool and/or the mandrel for the machining is reached. Higher material volumes M are not admissible, since the characteristic curve K1 intersects the abscissa of the material volume M.

If, nonetheless, a material volume M for one route increment is calculated that is higher than the admissible material limit volume M_{G}, then the machining on the machine tool is no longer carried out for this route increment. The controller of the machine tool stops said tool before, since it was identified, in the temporally preceding calculation of the engagement parameter, that an inadmissible loading of the tool and/or mandrel would occur.

In FIG. 3, a characteristic curve K1′ is plotted in a dashed line, in which curve the calculated material volume M_{b} for a route increment is within the admissible range of the stored characteristic curve K1, i.e. is smaller than M_{G}. The machining is then carried out with the advancement predetermined by the characteristic curve K1′ and/or the predetermined rotational speed, for the route increment. In this case, the measured vibrations and/or calculated machining forces are evaluated as to whether they are too high, suitable, or too low for the tool that is used. FIG. 3 shows the case where the measured vibrations and/or the calculated machining forces were high. Consequently, the characteristic curve drops by a few percent, in the region of M_{b}, which is shown in FIG. 3 by the dashed line K1′. When the characteristic curve drops, it is preferably ensured that the gradient of the characteristic curve always remains negative. That is to say that the characteristic curve K1′ drops steadily as the material volume M increases, as shown in FIG. 3.

FIG. 4 shows the reverse case compared with FIG. 3, where the machining is carried out for a calculated material volume M_{b} for a route increment, and the measured vibrations and/or the calculated machining forces are low. Consequently, the characteristic curve K2 rises by a few percent, in the region of M_{b}, which is shown in FIG. 4 by the dashed line K2′. In this case, again the gradient of the adjusted characteristic curve K2′ over the material volume M is negative overall.

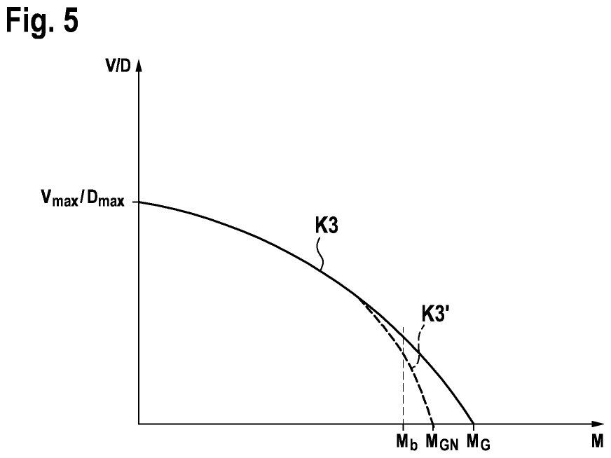

FIG. 5 additionally shows that a change in the characteristic curve K3′ owing to measured vibrations and/or calculated machining forces can also influence the maximally permissible material limit volume M_{G} per route increment. The material volume M_{b} calculated in said route increment is relatively close to the maximally permissible material limit volume M_{G}. The machining of the workpiece, which now follows, is carried out with the advancement resulting from the characteristic curve and/or the resulting rotational speed, and the measured vibrations and/or calculated machining forces are high. Therefore, the characteristic curve K3 drops in the region for M_{b}. This is shown in FIG. 5 by the dashed characteristic curve K3′. The result of this is that the characteristic curve K3′ already meets the abscissa at a smaller material volume M per route increment, and thus a new maximally admissible material limit volume M_{GN} results, which may no longer be exceeded. Thus, the new maximally admissible material limit volume M_{GN} becomes a new upper limit for the admissible material volume M per route increment. Machining operations in which a high material volume per route increment is calculated are interrupted.

1. A method for operating a machine tool which is configured for machining a workpiece blank using a tool, comprising the steps of:
determining geometry data of the workpiece blank,
determining geometry data of a tool used for machining the workpiece blank,
dividing a tool path for machining the workpiece blank into a plurality of route increments,
simulating a material removal on the workpiece blank by means of the tool per the route increment, and
calculating an engagement ratio between the workpiece blank and tool per the route increment for determining an engagement parameter,
wherein an advancement and/or a rotational speed of the tool relative to the workpiece blank is adjusted depending on the engagement parameter.

2. The method according to claim 1, wherein a length of the route increment corresponds to the route that the tool travels, at a predetermined path speed and a predetermined rotational speed during a number in a range of one to five rotations.

3. The method according to claim 1, wherein the engagement ratios are determined based on a material volume which is removed from the workpiece blank by the tool during a relative movement between the tool and workpiece blank along a route increment.

4. The method according to claim 1, wherein the engagement ratios are determined based on an immersion depth of the tool into the workpiece blank, which corresponds to a difference between a lowest contact point and a highest contact point of the tool with material of the workpiece blank in the a direction of an axis of rotation of the tool.

5. The method according to claim 1, wherein the engagement ratios are determined based on a wrapping which specifies the an angular region over which a cutting edge of the tool is in engagement with the material of the workpiece blank during a rotation of the tool.

6. The method according to claim 1, wherein the engagement ratios are determined based on a size of a surface over which a bounding volume of the tool, which results from a rotation of the tool, is in engagement with the material of the workpiece blank.

7. The method according to claim 1, wherein the engagement ratios are determined based on an angle of a path between the tool and workpiece blank relative to an axis of rotation of the tool.

8. The method according to claim 1, wherein a calculation of the engagement parameters of the engagement ratios for each individual route increment takes place temporally first, before the tool is moved along the calculated route increment, relative to the workpiece blank.

9. The method according to claim 1, wherein for each tool one or more characteristic curves for engagement parameters per route increment are stored in a controller, which specifies how the advancement and/or rotational speed are adjusted for individual input parameters.

10. The method according to claim 1, wherein during machining, vibrations and/or machining forces calculated from motor currents of an electric drive of an advancement shaft or a mandrel shaft are detected, in particular by means of sensors, and
if detected vibrations and/or calculated machining forces fall below a limit value predetermined in a controller, the advancement and/or rotational speed are increased in order to increase a machining speed at a constant machining quality, and
if detected vibrations and/or calculated machining forces fall below the limit value predetermined in the controller, the advancement and/or rotational speed are reduced in order to reduce a machining speed.

11. The method according to claim 1, wherein during machining, vibrations and/or machining forces calculated from motor currents of an electric drive of an advancement shaft or a mandrel shaft are detected, in particular by means of sensors, and
if detected values for vibrations and/or machining forces fall below limit values predetermined in a controller, a characteristic curve for the tool that is used rises in a region of the calculated engagement parameter for advancement and/or rotational speed, in order to increase a machining speed at a constant machining quality, if the engagement parameter is again calculated at a same magnitude, in a case of machining along a route increment, and
if detected values for vibrations and/or machining forces exceed limit values predetermined in the controller, the characteristic curve for the tool that is used drops in the region of the calculated engagement parameter for advancement and/or rotational speed, in order to reduce a machining speed, if the engagement parameter is again calculated at the same magnitude, in the case of machining along a route increment.

12. The method according to claim 9, wherein a separate characteristic curve is defined for each material property of a workpiece blank to be machined using a tool, which characteristic curve is adjusted based on the engagement parameters, for future machining.

13. The method according to claim 10, wherein the limit value with respect to vibrations and/or calculated machining forces are defined separately for each tool.

14. The method according to claim 10, wherein a characteristic curve is designated as optimized if the detected vibrations and/or calculated machining forces in the controller are located in a normal range.

15. The method according to claim 14, wherein wear monitoring is carried out by means of monitoring of detected vibrations and/or calculated machining forces in the controller, during machining with calculated engagement parameters and optimized characteristic curves of set advancement and/or rotational speed values, for limit values.

16. The method according to claim 15, wherein in a case of a deviation of the detected vibrations and/or calculated machining forces in the controller from limit values during machining with advancement and/or rotational speed values set according to calculated engagement parameters and optimized characteristic curves, the machining is interrupted and optionally a new sister tool is substituted.

17. The method according to claim 9, wherein in a case of a deviation of a detected vibration and/or calculated machining forces in the controller above or below a predetermined limit value, wear of the tool is concluded.

18. A machine tool configured for carrying out a method according to claim 1.
